(19) United States
(12) Patent Application Publication
(10) Pub. No.: US 2015/0231617 A1
(43) Pub. Date: Aug. 20, 2015

(54) Fe-SAPO-34 CATALYST FOR USE IN NOX REDUCTION AND METHOD OF MAKING

(71) Applicant: Ford Global Technologies, LLC, Dearborn, MI (US)

(72) Inventors: Stanislava Andonova, Gothenburg (SE); Stefanie Tamm, Gothenburg (SE); Louise Olsson, Gothenburg (SE); Clifford Norman Montreuil, Livonia, MI (US); Christine Kay Lambert, Dearborn, MI (US)

(21) Appl. No.: 14/597,134

(22) Filed: Jan. 14, 2015

Related U.S. Application Data
(60) Provisional application No. 61/941,717, filed on Feb. 19, 2014.

(51) Int. Cl. B01J 29/85; B01D 53/94; B01J 37/08; B01J 37/04; C01B 39/54; B01J 35/02

(52) U.S. Cl. CPC B01J 29/85; C01B 39/54; B01J 35/02; B01J 37/082; B01J 37/04; B01D 53/9418; B01D 53/9431; B01J 2229/183; B01D 2255/50; B01D 2255/902; B01D 2255/903

(57) ABSTRACT

The system and methods described provide for an Fe-SAPO-34 catalyst in an SCR catalyst for reducing nitrogen oxides (NOx) from vehicle engine exhausts. In one example, the catalyst is formed by incorporating iron during synthesis of the SAPO-34 zeolite, which allows iron to be incorporated into the zeolite crystal lattice structure and eliminates the post-synthesis ion-exchange step. The resulting Fe-SAPO-34 catalyst, which may be used in combination with or in addition to a Cu-CHA catalyst, exhibits good high temperature activity at temperatures above 550° C. and provides for a good thermal stability.

### CROSS REFERENCE TO RELATED APPLICATIONS

The present application claims priority to U.S. Provisional Patent Application No. 61/941,717, “Fe-SAPO-34 Catalyst for Use in NOx Reduction and Method of Making,” filed on Feb. 19, 2014, the entire contents of which are hereby incorporated by reference for all purposes.

### FIELD

The present description relates to the preparation and use of iron zeolite catalysts in reducing nitrogen oxides (NOx) from vehicle exhausts, and more particularly, to an Fe-SAPO-34 catalyst useful as an SCR catalyst for the reduction of nitrogen oxides.

### BACKGROUND AND SUMMARY

In recent years, government regulations in the United States and other places have restricted emissions of nitrogen oxides (NOx) from vehicle engine exhausts. These measures have produced increased efforts to develop catalysts for use in vehicle exhaust systems that function to stimulate the reduction of NOx. A number of catalysts are known that convert exhaust components to environmentally acceptable compounds. For example, selective catalytic reduction catalysts (SCR) are used to convert NOx to N2. SCR devices may comprise metal-promoted zeolites and utilize an ammonia reductant in the form of aqueous urea, which is injected in the exhaust stream. In view of this composition, SCR catalysts may retain acceptable catalytic activity over a wide range of temperature conditions encountered in vehicle exhaust systems, for example, from about 200° C. to 600° C. or higher.

Two types of catalysts are often used for selective catalytic reduction of NOx from gasoline or diesel engine exhaust. The first type is based on a copper zeolite catalyst having a chabazite (CHA) framework, e.g., copper chabazite zeolite catalysts. CHA is a tectosilicate mineral having the general formula (Ca, K₂, Na₂)₂ [Al₂Si₄O₁₂]₂. However, such catalysts tend to lose activity at higher temperatures, for instance, greater than 550° C., and may actually increase NOx production by oxidizing ammonia. A second type of SCR catalyst is based on iron-zeolite catalysts comprising beta-type zeolites, e.g., iron-exchanged beta zeolite (BEA). Such catalysts provide adequate NOx reduction at high temperatures but also suffer from other disadvantages. For example, beta zeolites have insufficient thermal stability for prolonged use at high temperatures and further tend to adsorb large amounts of hydrocarbons, which can result in exothermic reactions capable of damaging the catalyst.

While incorporation of metals such as iron into chabazite zeolites is desirable to achieve both high activity and improved thermal stability, incorporation of iron particles into chabazite zeolites such as SSZ-13 has been difficult using traditional ion-exchange methods. The difficulty incorporating iron into chabazite zeolites is due to the small pore openings of the chabazite structure. For example, an SSZ-13 CHA has a pore size of about 3 to 5 Angstroms. Another known chabazite structure comprises silicoaluminophosphates (SAPOs) having the formula (SiO₂)x(Al₂O₃)y(P₂O₅)z. In particular, SAPO-34 has been proposed for use as a catalyst in various reactions since it demonstrates high selectivity and a high catalytic activity, which may be due to the high Bronsted acidity of the material. However, incorporation of iron in such catalysts has also been difficult using traditional ion exchange processes due to the small pore openings in the SAPO chabazite structure. Accordingly, there is a need in the art for a metal-based SCR catalyst for use in reducing nitrogen oxides that provides both improved high temperature activity and thermal stability over the range of temperatures encountered in vehicle exhaust systems.

The inventors have recognized issues with such approaches and herein describe systems and methods for a vehicle engine exhaust with iron incorporated into the crystal structure of the zeolite catalyst. In one particular example, the method of making an Fe-SAPO-34 catalyst comprises preparing an aqueous mixture containing an alumina source, phosphoric acid, and water; adding iron from an iron rich source to said mixture; adding a templating agent said mixture; and calcining said mixture to form said catalyst. With this arrangement, the catalyst is formed by incorporating iron during synthesis of the SAPO-34 zeolite, which allows iron to be incorporated into the zeolite crystal lattice structure and eliminates the post-synthesis ion-exchange step. As described herein, adding iron to said mixture includes adding iron to said mixture in the form of an iron nitrate. In this way, the technical result is achieved that nitrogen oxide emissions are reduced in vehicle engine exhausts by utilizing a SAPO-34 catalyst which includes iron in the chabazite crystal structure. The Fe-SAPO-34 catalyst further exhibits substantial activity at high temperatures (e.g., at temperatures greater than 550° C.) as well as thermal stability at such temperatures.

The above advantages and other advantages, and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 shows a schematic illustration of an exhaust treatment system including the Fe-SAPO-34 SCR catalyst in accordance with an embodiment of the invention;

FIG. 2 is a schematic illustration of an exhaust treatment system including a combined Fe-SAPO-34 SCR catalyst and Cu-CHA catalyst in accordance with another embodiment of the invention;

FIGS. 3A and 3B show example illustrations wherein an SCR catalyst according to the present disclosure is configured with zones that include combinations of the Fe-SAPO-34 catalyst and Cu-CHA catalyst;

FIGS. 4A and 4B are graphs showing % NOx conversion versus temperature for aged and fresh samples of Fe-SAPO-34 catalysts in accordance with an embodiment of the invention;

FIG. 5 is a graph of the % NOx conversion of the samples of FIG. 4;

FIGS. 6A, 6B and 6C are graphs illustrating the effect of aging on NOx and NH3 conversion versus temperature for Fe-SAPO-34 catalyst samples prepared in accordance with an embodiment of the present invention in comparison with an exemplary Cu-CHA catalyst that is Cu-SAPO-34;

FIGS. 7A and 7B are graphs illustrating the effect of aging on NOx and NH3 on a combined Fe-SAPO-34 and Cu-SAPO-34 catalyst in comparison with a Cu-SAPO-34 catalyst alone; and

FIG. 8 shows an example method for preparing an Fe-SAPO-34 catalyst with iron incorporated therein according to the present description.

### DETAILED DESCRIPTION

The use of an Fe-SAPO-34 catalyst for reducing vehicle exhaust emissions provides advantages over other SCR catalysts such as copper-chabazite zeolite catalysts and iron-exchanged beta-zeolite catalysts as it provides greater NOx reduction activity at temperatures greater than 450° C., is thermally stable, and does not exhibit high hydrocarbon adsorption due to a relatively small pore size. In addition, by incorporating the iron into the zeolite crystal structure during synthesis of the SAPO-34 chabazite, the post-synthesis ion exchange step wherein iron is added but not substantially incorporated into the crystal structure is not performed, which allows for a simplification of the preparation methods in some instances. For example, conventional ion-exchange methods incorporate the cation introduced inside the crystal structure by replacing cations at the Bronsted (or proton donor) sites. However, attempts to incorporate iron by such ion-exchange methods have been difficult until now due to the small pore size of chabazite relative to iron particles to be incorporated therein. Furthermore, any iron successfully exchanged by relocation into the chabazite tends to be located superficially at the surface of the chabazite. In contrast, by adding iron during synthesis of the SAPO-34 catalyst, the iron may become incorporated into or entrapped within the SAPO-34 crystal structure throughout the entirety of the structure (e.g., >90% of the sites available in the SAPO-34 catalyst occupied by an iron particle or ion).

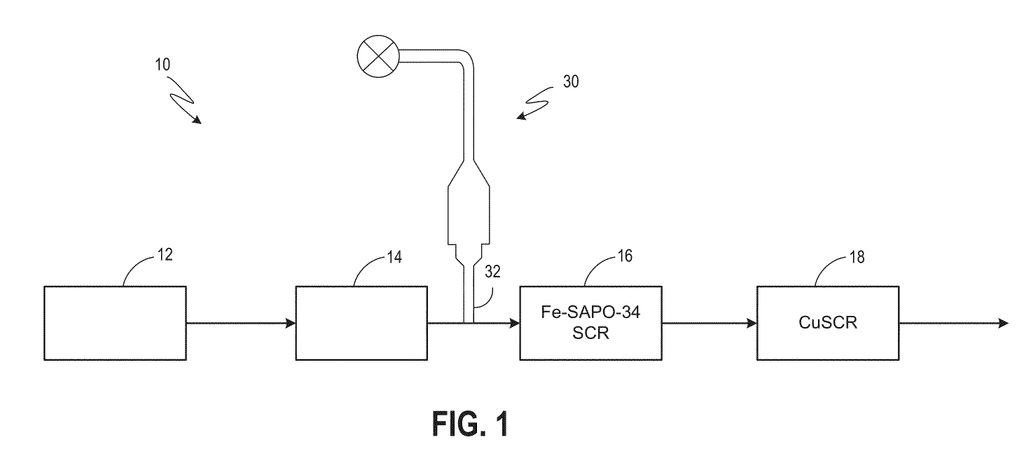

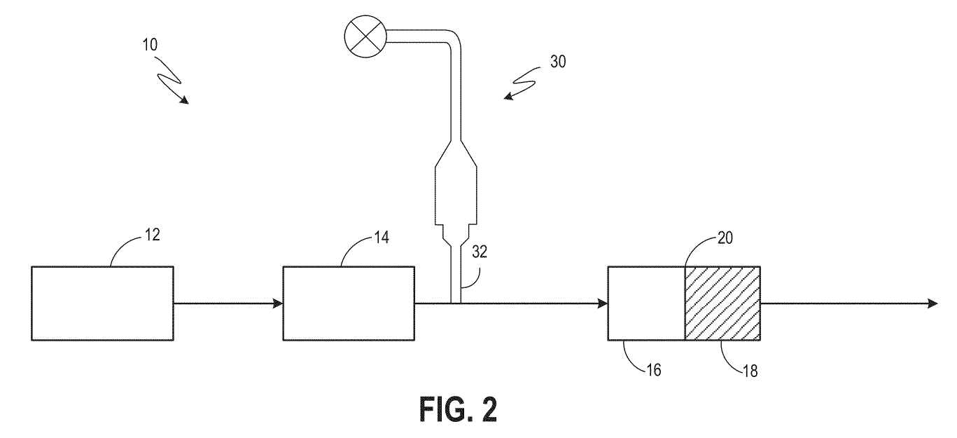

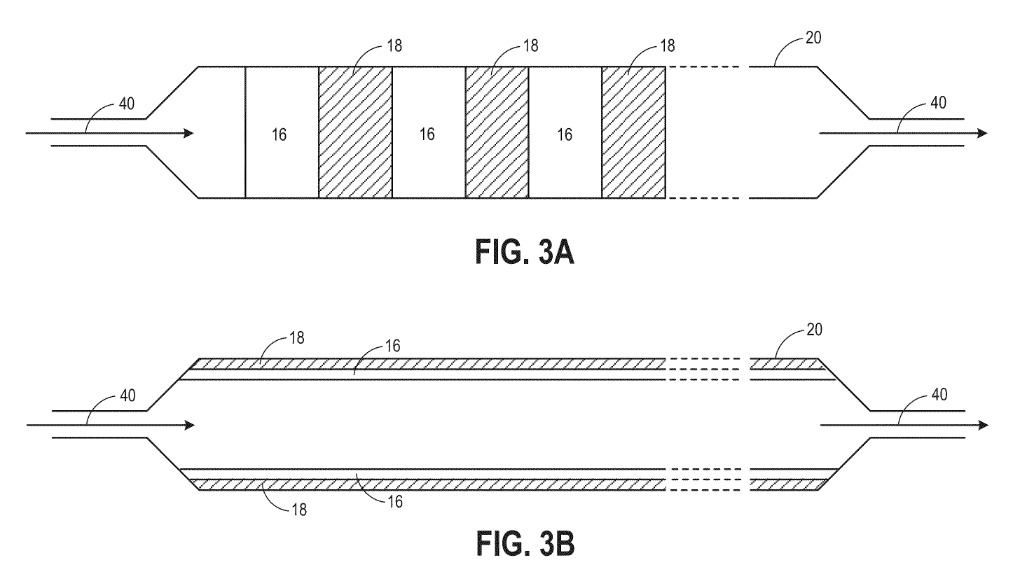

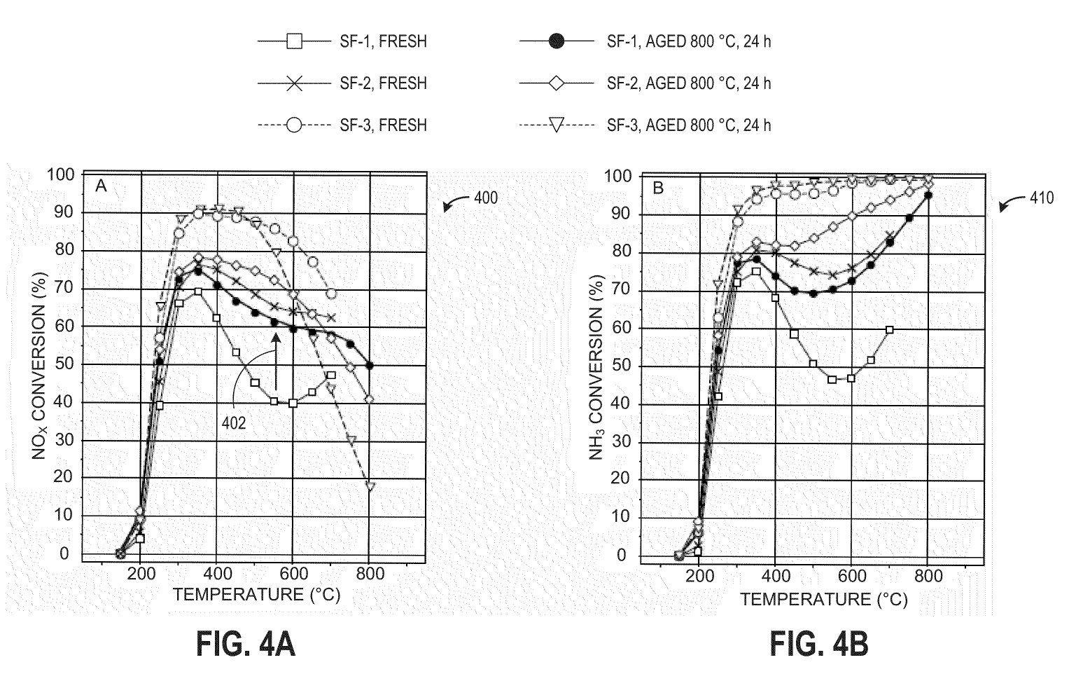

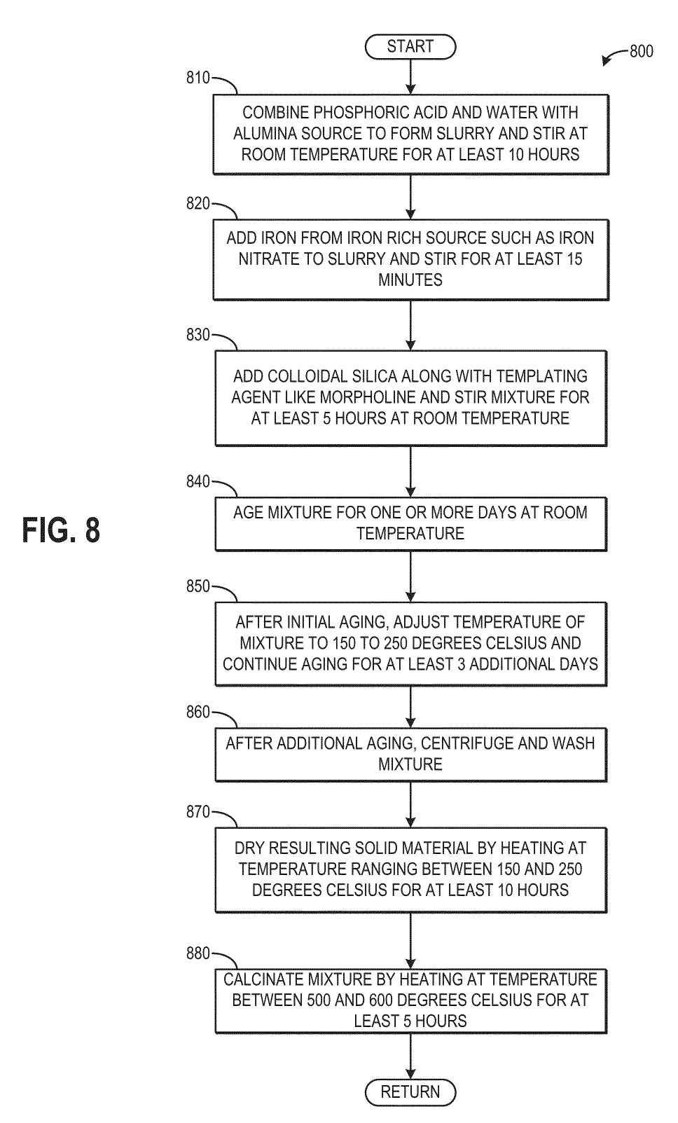

For this reason, FIGS. 1 and 2 show schematic illustrations of an exhaust treatment system including the Fe-SAPO-34 SCR catalyst in accordance with embodiments of the present disclosure. Then, FIGS. 3A and 3B show example illustrations of an SCR catalyst configured with zones that include the Fe-SAPO-34 catalyst in combination with a Cu-CHA catalyst. During preparation or synthesis of an Fe-SAPO-34 catalyst, inclusion of an aging step produced an overall increase in the NOx and NH3 conversion. Therefore, FIGS. 4A-7B illustrate various graphs that show such conversions Fe-SAPO-34 catalysts in accordance with the present disclosure. Heretofore, methods for incorporating iron into the zeolite crystal structure of a catalyst have not been implemented. Therefore, FIG. 8 shows an example method for preparing an Fe-SAPO-34 catalyst with iron incorporated therein. In order that the description may be more readily understood, reference is made to the following examples which are intended to illustrate embodiments of the invention, but not limit the scope thereof.

Referring now to FIG. 1, one embodiment of an exhaust treatment system 10 is shown which includes the Fe-SAPO-34 catalyst. As shown, the exhaust treatment system is coupled to an exhaust manifold 12 of a vehicle engine including an oxidation catalyst 14, for example. Thus, an SCR catalyst 16 comprising an Fe-SAPO-34 catalyst in accordance with an embodiment of the present invention is positioned downstream from the oxidation catalyst. The treatment system may further include a reductant delivery system 30 coupled to the exhaust manifold upstream of SCR catalyst 16. A reductant, such as ammonia, aqueous urea, or other ammonia-generating compound, is delivered to the reductant delivery system in metered amounts, typically in the form of a vaporized mixture of the reductant and water. The reductant delivery system further includes an injector 32 for injecting the reductant into the exhaust stream at the appropriate time.

Treatment system 10 may further include a second SCR catalyst 18 downstream from the Fe-SAPO-34 catalyst. For example, such an SCR catalyst may comprise a conventional Cu-chabazite (or CHA) catalyst or, in particular, a Cu-SAPO-34 catalyst. Where the catalyst comprises a Cu-CHA catalyst, the catalyst is preferably formed from an SSZ-13 chabazite. As shown in the example of FIG. 1, exhaust treatment system 10 is an exhaust treatment system comprising an SCR catalyst positioned in an exhaust passage of an engine, wherein said SCR catalyst comprises an Fe-SAPO-34 catalyst. Moreover, according to the present description, the SAPO-34 zeolite is formed with iron incorporated therein, the iron being incorporated into the crystal lattice structure of said zeolite during synthesis of said zeolite without an ion-exchange step. According to the embodiment shown, the Cu-CHA catalyst is included within a second SCR catalyst positioned downstream of the Fe-SAPO-34 catalyst. During operation, as exhaust gas generated by the engine passes through the exhaust gas manifold 12, it passes through the diesel oxidation catalyst 14 such that unburned hydrocarbons and CO are oxidized to CO2 and water vapor. The exhaust gas then flows through the Fe-SAPO-34 catalyst 16 such that NOx is removed from the gas stream by selective catalyst reduction with ammonia supplied from the reductant delivery system 30 to form nitrogen and water vapor.

However, other examples are possible and the Fe-SAPO-34 catalyst and Cu-CHA (e.g., Cu-SAPO-34 catalyst) may also be formed into a single catalyst. For this reason, an alternative embodiment is illustrated in FIG. 2 where an SCR catalyst 20 is provided that comprises a Fe-SAPO-34 catalyst 16 combined with a Cu-CHA catalyst 18 on a single catalyst support. These catalysts may be provided in zones on one substrate, for example, with Fe-SAPO-34 16 in one zone as shown, and Cu-CHA 18 or, in some implementations, Cu-SAPO-34 in another zone. In view of the catalyst of FIG. 2, the exhaust treatment system may further include one or more of a Cu-CHA catalyst in addition to the Fe-SAPO-34 catalyst, wherein the Fe-SAPO-34 catalyst and the Cu-CHA catalyst are coated in zones on a single substrate in the exhaust passage of said engine.

Alternatively, the catalyst may comprise multiple layers comprising the Fe-SAPO-34 catalyst and the Cu-CHA. FIGS. 3A and 3B show two such example illustrations wherein the SCR catalyst formed according to the present disclosure includes different zones that include combinations of the Fe-SAPO-34 catalyst and the Cu-CHA catalyst. For simplicity, a repeating structure of zones is shown. However, this is non-limiting and in other embodiments, other zonal structures may be alternatively employed within the catalyst unit.

In FIG. 3A, SCR catalyst 20 includes alternatively repeating zones of Fe-SAPO-34 16 and Cu-CHA 18, which may be Cu-SAPO-34 as one example. During operation, as exhaust gas 40 generated by the engine passes through SCR catalyst 20, it passes through the various zonal regions of the catalyst. Although shown including more than two repeating regions, in some examples two repeating regions may be present. However, this is non-limiting and examples including a multiplicity of repeating regions (e.g., three or more) may be present, as shown.

FIG. 3B shows catalyst 20 including a layered structure of the zonal region. In this way, the SCR catalyst according to the present invention may include the different zones arranged into layers within the wall of the SCR catalyst, wherein coating the Fe-SAPO-34 catalyst and the Cu-CHA catalyst includes arranging the zones into multiple layers with an overlayer-underlayer structure. For example, as shown, the overlayer-underlayer structure includes coating the Fe-SAPO-34 16 overlayer on top of the Cu-CHA catalyst 18 that is coated as the underlayer, the multiple layers forming the wall of the SCR catalyst. In other words, SCR catalyst 20 is configured with an Fe-SAPO-34 overlayer on a Cu-CHA underlayer. For example, if a high porosity (greater than 50%) ceramic substrate is used, the Cu-CHA could be coated within the wall and Fe-SAPO-34 could be coated as an overlayer.

The resulting Fe-SAPO-34 catalyst may be used in the form of an extruded stand-alone catalyst or may be washcoated on a substrate. The substrate may comprise any suitable monolithic substrate such as cordierite, silicon carbide, aluminum titanate, aluminum oxide, or metals including foams, foils and fibers made of stainless steel or nickel alloys. The monolith may also have particle filtration properties.

The Fe-SAPO-34 catalyst may be formed into a slurry and applied as a washcoat to the substrate by adding a binder such as silicon oxide, titanium oxide, or zirconium oxide. When applied as a washcoat onto a monolithic substrate, the catalyst composition is preferably deposited to provide a concentration of about 0.5 to 4.0 g/in³. The coated substrate is then preferably dried and calcined to provide an adherent coating. The catalyst may be applied in one or more layers to the substrate. The Fe-SAPO-34 catalyst may also be zone coated in the substrate, for example, a different formulation may be provided in one or more zones. For example, the zones may provide NOx reduction via SCR, oxidation of NO to promote faster SCR reactions, or oxidation of NH3 for slip control.

In a method for treating engine exhaust gases the Fe-SAPO-34 catalyst is positioned in the exhaust passage of an engine and is exposed to engine exhaust gas emissions containing NOx such that at least a portion of the emissions are converted to N2 at a temperature between about 150° C. to 170° C. As noted above, the method may include a second SCR catalyst comprising a Cu-CHA which may be Cu-SAPO-34 as one example and exposing the engine exhaust gases to the second catalyst downstream from the Fe-SAPO-34 catalyst. The method may also include treating engine exhaust gases with the Fe-SAPO-34 catalyst in combination with the Cu-CHA catalyst on a single catalyst support.

### Examples

Turning now to exemplary data illustrating increased NOx conversion, FIGS. 4A-7B illustrate various graphs that show conversions for Fe-SAPO-34 catalysts in accordance with the present disclosure.

Samples of SAPO-34 with and without iron were produced as follows:

Phosphoric acid and water were combined with an alumina source such as pseudoboehmite to form a slurry. The mixture was then stirred at room temperature for 12 hours. In all samples except for one, iron was added in the form of iron nitrate. The mixture was stirred for 30 minutes, and colloidal silica was then added along with morpholine, which is an exemplary templating agent. The resulting mixture was then stirred for 7 hours at room temperature followed by aging for 24 hours at room temperature and 72 hours at 200° C. Thereafter, the mixture was centrifuged and washed in a washing step, and the resulting solid material was dried at 200° C. for 12 hours followed by calcination at 560° C. for 6 hours. The composition of the exemplary samples is shown in Table 1 below.

TABLE 1
Chemical Composition (wt %)

| Sample | SiO₂ | Al₂O₃ | Fe₂O₃ | P₂O₅ |
|---|---|---|---|---|
| SAPO-34 | 13.9 | 37.8 | <0.1 | 31.6 |
| SF-1 | 14.4 | 38.2 | 0.381 | 33.2 |
| SF-2 | 14.7 | 39.3 | 0.663 | 34.7 |
| SF-3 | 12.0 | 24.4 | 1.46 | 28.2 |

SAPO-34 without iron was also tested for reference. The SAPO-34 sample without iron was found to contain 13.9 wt % SiO₂, 37.8% Al₂O₃, and 31.6% P₂O₅. Samples SF-1, SF-2 and SF-3 contained varying iron contents. The crystalline structure of the samples was studied using X-ray diffraction (XRD), and the addition of iron to SAPO-34 did not change the zeolite structure. The BET surface areas of the samples were measured and did not vary significantly except for the SF-3 sample, which exhibited a higher surface area (e.g., 671.3 m² g⁻¹). Thus, the higher iron content may influence the SAPO structure and thereby increase the surface area, for example. Testing for NOx and NH3 conversion reactions was performed before and after iron-containing samples were aged at 800° C. in flowing, humid air for 24 hours. Each sample was tested as a coated monolith on a ceramic honeycomb substrate.

FIG. 4A is a graph 400 showing % NOx conversion versus temperature for aged and fresh samples of Fe-SAPO-34 catalysts in accordance with an embodiment of the invention. FIG. 4B is a graph 410 showing % NH3 conversion versus temperature for the aged and fresh samples of Fe-SAPO-34 catalysts. As shown in FIGS. 4A and 4B, a substantial improvement in overall NOx and NH3 conversion was observed after the aging procedure. For example, arrow 402 is included to illustrate the increased % NOx conversion for the aged sample of SF-1 compared to the fresh sample that was not aged at 800° C. for 24 hours. Likewise, various degrees of enhanced NOx and NH3 conversion were also observed in the other samples, although the graphs do not explicitly include arrows for the increased conversion for simplicity.

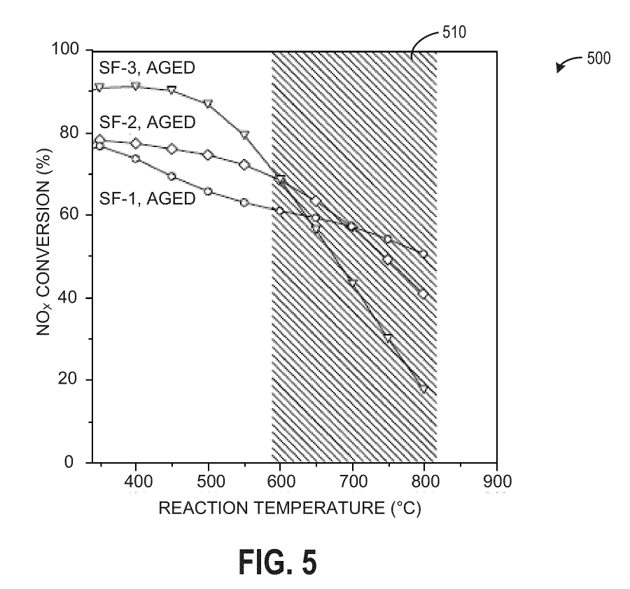

FIG. 5 is a graph 500 of the % NOx conversion of the samples of FIG. 4 at higher temperatures that fall in the temperature range 510 extending from nearly 600 to 800 degrees Celsius. FIG. 5 illustrates the high temperature performance of the aged catalysts in greater detail. As illustrated, at 650° C., the Fe-SAPO-34 catalysts shown achieved about 60% NOx conversion. A 60% NOx conversion represents a substantially higher conversion (e.g., enhanced performance) than currently achieved using a commercial Cu-CHA catalyst, which may have close to zero or even negative NOx conversion at such high temperatures.

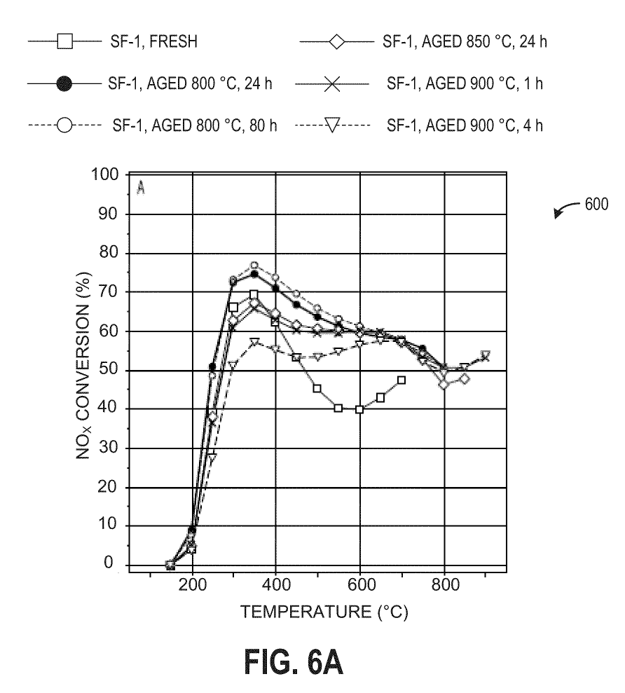

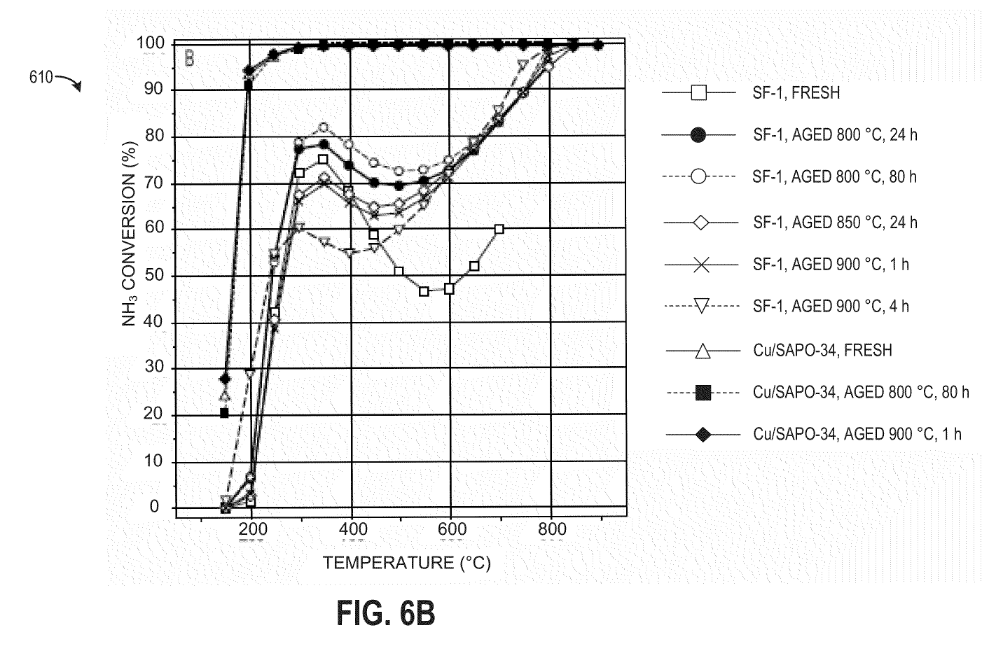

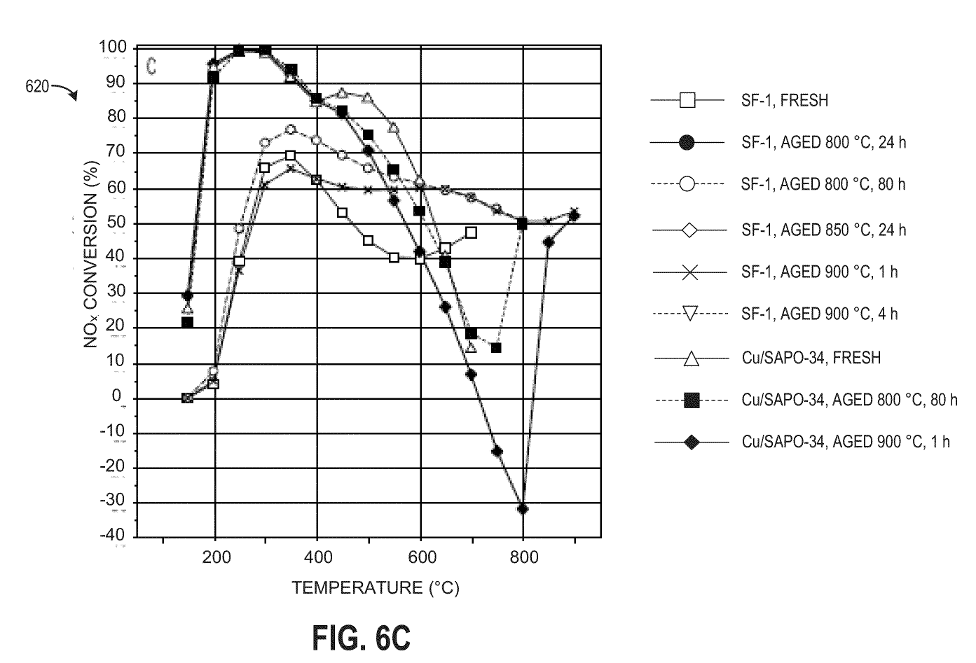

FIGS. 6A, 6B and 6C are graphs 600, 610, and 620, respectively, that illustrate the effect of aging on NOx and NH3 conversion versus temperature for Fe-SAPO-34 catalyst samples prepared according to the present invention relative to a Cu-SAPO-34 catalyst. Said differently, in FIGS. 6A-6C, the activity of a Cu-SAPO-34 catalyst is compared with the prepared Fe-SAPO-34 samples. Therein, the conversion of Cu-SAPO-34 catalysts exceed that of Fe-SAPO-34 catalysts at temperatures below 500° C. However, based on the graphs shown, the conversion of Cu-SAPO-34 catalyst was deficient relative to the Fe-SAPO-34 catalysts at higher temperatures, e.g., temperatures above 500° C. that are typically used in filter regeneration. Accordingly, the use of a system including a Fe-SAPO-34 catalyst, either alone or in combination with or in addition to, a Cu-CHA catalyst like Cu-SAPO-34, may further provide a stable and increased SCR performance over a wider temperature window, particularly at higher temperatures.

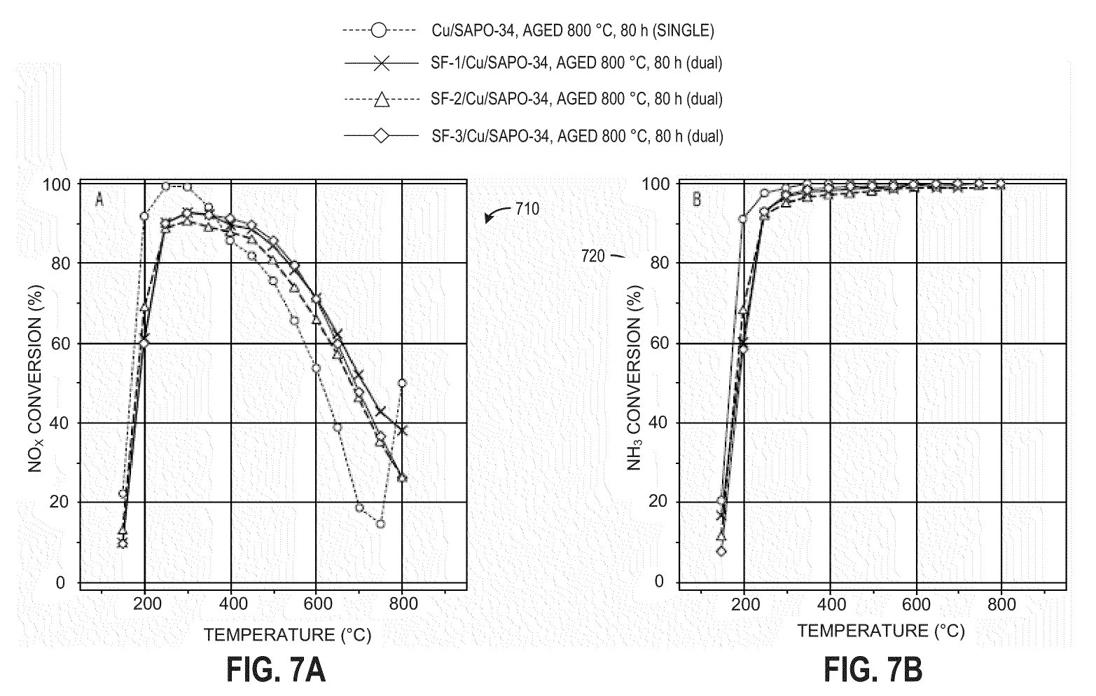

FIGS. 7A and 7B are graphs illustrating the effect of aging on NOx (e.g., graph 710) and NH3 (e.g., graph 720) on a combined Fe-SAPO-34 and Cu-SAPO-34 catalyst in comparison with a Cu-SAPO-34 catalyst alone. FIGS. 7A and 7B illustrate the NOx and NH3 conversion performance of a Cu-SAPO-34 catalyst after aging in comparison with a combined Fe-SAPO-34/Cu-SAPO-34 catalyst. As can be seen, the combined catalyst provides increased conversion over a wider temperature range.

Turning now to a method for producing an Fe-SAPO-34 catalyst according to the present disclosure, FIG. 8 shows example method 800 for preparing an Fe-SAPO-34 catalyst with iron incorporated therein. As described, the Fe-SAPO-34 catalyst exhibits enhanced performance compared to other chabazite zeolite catalyst materials because iron is incorporated into the crystal structure during synthesis of the chabazite rather than by using conventional ion-exchange techniques performed in a post-synthesis step.

According to one aspect of the invention, an Fe-SAPO-34 catalyst is provided that comprises a SAPO-34 zeolite including iron incorporated into the crystal lattice structure of said zeolite, the iron incorporated into the crystal lattice structure during synthesis of said zeolite without an ion exchange step. In other words, the SAPO-34 zeolite includes iron therein, wherein the iron has been incorporated into the crystal lattice structure of the zeolite during synthesis of the zeolite, not by an ion-exchange step.

Preferably, the Fe-SAPO-34 catalyst is formed into a slurry and washcoated onto a substrate such as a cordierite monolith or a wall-flow substrate for use as an SCR catalyst. For this reason, the Fe-SAPO-34 SCR catalyst according to the present disclosure may be formed by washcoating the SAPO-34 zeolite including iron incorporated therein onto a substrate selected from one of a cordierite monolith and a silicon carbide wall-flow filter. As described, iron may be present in the SAPO-34 catalyst in an amount of from about 0.25 wt % to about 2.0 wt %, and preferably, in an amount of from about 0.4 wt % to about 1.5 wt %, based on a total weight of chabazite. In one embodiment, the Fe-SAPO-34 catalyst has a surface area of at least 500, and preferably, about 600 m²/g, as measured from the dried slurry.

However, according to another embodiment of the invention, a method 800 of making an Fe-SAPO-34 catalyst is provided which comprises forming a slurry comprising phosphoric acid, water, and a source of alumina, as shown at 810. In one example, the alumina source comprises pseudoboehmite. However, other examples are also possible and may be used in some instances. The Fe-SAPO-34 catalyst is preferably prepared by combining phosphoric acid and water with an alumina source such as pseudoboehmite to form a slurry. The mixture is preferably stirred at room temperature for about 10 to 15 hours, followed by the addition of iron in the form of an iron nitrate.

At 820, method 800 includes adding iron from an iron rich source to said mixture. As described herein, iron is added to the slurry in the form of ferric nitrate. In one example, the ferric nitrate is included in the mixture in an amount of about 5 to about 100% by weight, and more preferably, about 5 to 20% by weight. Unless otherwise indicated, the disclosure of any ranges in the specification and claims are to be understood as including the range itself and also anything subsumed therein, as well as the endpoints indicated by specified range. Although exemplary ranges are provided, the ranges may include performing the method for a time period that exceeds the lower range indicated. For example, stirring the mixture for about 15 to 45 minutes, may include stirring the mixture for at least 15 minutes in some instances.

At 830, method 800 includes adding colloidal silica to the slurry along with a templating agent. In one example, the templating agent comprises morpholine. Thereafter, the method includes aging the mixture before drying and calcination to form the catalyst. Thus, step 830 includes adding colloidal silica along with a templating agent such as morpholine. This mixture is then stirred for about 5 to 10 hours (e.g., at least 5 hours) at room temperature followed by an aging process that has been found to increase the conversion of NOx in some instances.

At 840, method 800 includes aging the sample for about 23 to 25 hours (or 1 day, for example) at room temperature. Then, at 850, method 800 includes adjusting the temperature of the mixture to a range between 150 and 250 degree Celsius after the aging, and continuing to age the mixture for 70 to 75 hours (e.g., at least 3 additional days) at about 150° C. to 250° C., followed by centrifugation and washing, as indicated at step 860.

At 870, the resulting solid material is then dried at about 150° C. to 250° C. for about 10 to 15 hours (e.g., at least 10 hours), followed by calcination at 880 that includes heating the mixture at about 500° C. to 600° C. for about 5 to 7 hours (e.g., greater than 5 hours). Thus, the method further includes calcining said mixture to form said catalyst by heating the mixture at a temperature between 500 and 600 degrees Celsius for at least 5 hours.

The Fe-SAPO-34 catalyst is incorporated as an SCR catalyst in an exhaust treatment system in which the Fe-SAPO-34 catalyst is positioned in the exhaust passage of a vehicle engine in one example. For this reason, the system further includes combining the Fe-SAPO-34 catalyst with a Cu-CHA catalyst and in particular a Cu-SAPO-34 catalyst in some instances that may be included within a second SCR catalyst positioned downstream of the Fe-SAPO-34 catalyst. In other words, an exhaust treatment system according to the present disclosure may further include a second SCR catalyst in the exhaust passage of the engine downstream from the Fe-SAPO-34 catalyst. In one example, the second SCR catalyst comprises a Cu-chabazite (CHA) catalyst that is Cu-SAPO-34. However, in another embodiment, the second SCR catalyst may alternatively or additionally comprise a Cu-SSZ-13 catalyst. In yet another embodiment, the Fe-SAPO-34 catalyst may be combined with the Cu-CHA catalyst positioned or placed in the exhaust passage of an engine.

Accordingly, it is a feature of embodiments of the invention to provide an Fe-SAPO-34 catalyst which reduces nitrogen oxides from a vehicle exhaust, and which provides good high temperature activity and exhibits thermal stability over the range of temperatures encountered in vehicle exhaust systems. The Fe-SAPO-34 catalyst may also be used in the treatment of exhaust gas streams from gasoline or diesel engines as an SCR catalyst for the reduction of nitrogen oxides. The catalyst may be provided in conjunction with other gas treatment components such as three-way catalysts, oxidation catalysts, other SCR catalysts, or particulate filters. Other features and advantages of the invention will be apparent from the following description, the accompanying drawings, and the appended claims.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of making an Fe-SAPO-34 catalyst, comprising:
preparing an aqueous mixture containing an alumina source, phosphoric acid, and water;
adding iron from an iron rich source to said mixture;
adding a templating agent said mixture;
calcining said mixture to form said catalyst.

2. The method of claim 1, wherein adding iron to said mixture includes adding iron to said mixture in the form of an iron nitrate.

3. The method of claim 1, wherein preparing the aqueous mixture containing the alumina source, phosphoric acid, and water further includes forming a slurry and stirring the slurry at room temperature for at least 10 hours.

4. The method of claim 3, further comprising adding the iron from the iron rich source to the mixture to form a slurry and stirring the resulting slurry for at least 15 minutes.

5. The method of claim 4, wherein adding the templating agent includes adding morpholine and stirring the mixture for at least 5 hours at room temperature.

6. The method of claim 5, further comprising adding colloidal silica along with the templating agent.

7. The method of claim 6, further comprising aging the mixture after adding the templating agent for one or more days at room temperature.

8. The method of claim 7, wherein the method includes adjusting the temperature of the mixture to a range between 150 and 250 degree Celsius after the aging, and continuing to age the mixture for at least 3 additional days.

9. The method of claim 8, further comprising drying a solid product after the additional 3 days of aging by heating the solid product for at least 10 hours at a temperature ranging from 150 to 250 degrees Celsius.

10. The method of claim 9, wherein calcining said mixture to form said catalyst includes heating the mixture at a temperature between 500 and 600 degrees Celsius for at least 5 hours.

11. An Fe-SAPO-34 SCR catalyst comprising:
a SAPO-34 zeolite including iron incorporated into the crystal lattice structure of said zeolite, the iron incorporated into the crystal lattice structure during synthesis of said zeolite without an ion exchange step.

12. The Fe-SAPO-34 SCR catalyst of claim 11, wherein said catalyst is formed by washcoating the SAPO-34 zeolite including iron incorporated therein onto a substrate selected from one of a cordierite monolith and a silicon carbide wall-flow filter.

13. The Fe-SAPO-34 SCR catalyst of claim 12, further comprising combining the Fe-SAPO-34 catalyst with a Cu-CHA catalyst, the combined iron and copper catalysts housed within a catalyst unit.

14. The Fe-SAPO-34 SCR catalyst of claim 13, wherein said Fe-SAPO-34 catalyst and said Cu-CHA catalyst are coated in zones on a single substrate within the catalyst unit.

15. The Fe-SAPO-34 SCR catalyst of claim 13, wherein said Fe-SAPO-34 catalyst and said Cu-CHA catalyst are coated in layers on a single substrate within the catalyst unit.

16. An exhaust treatment system comprising:
an SCR catalyst positioned in an exhaust passage of an engine; wherein
said SCR catalyst comprises an Fe-SAPO-34 catalyst including a SAPO-34 zeolite with iron incorporated therein, the iron being incorporated into the crystal lattice structure of said zeolite during synthesis of said zeolite without an ion-exchange step.

17. The exhaust treatment system of claim 16, further including a Cu-CHA catalyst, wherein the Fe-SAPO-34 catalyst and the Cu-CHA catalyst are coated in zones on a single substrate in the exhaust passage of said engine.

18. The exhaust treatment system of claim 16 wherein the Cu-CHA catalyst is included within a second SCR catalyst positioned downstream of the Fe-SAPO-34 catalyst.

19. The exhaust treatment system of claim 17, wherein coating the Fe-SAPO-34 catalyst and the Cu-CHA catalyst includes arranging the zones into multiple layers with an overlayer-underlayer structure.

20. The exhaust treatment system of claim 19, wherein the overlayer-underlayer structure includes coating the Fe-SAPO-34 overlayer on top of the Cu-CHA catalyst underlayer, the multiple layers forming the wall of the SCR catalyst.
